(19) United States
(12) Patent Application Publication
(10) Pub. No.: US 2009/0228798 A1
(43) Pub. Date: Sep. 10, 2009

(54) Synchronized display of media and recording of audio across a network

(75) Inventors: Janet H. Kephart, Denver, CO (US); Leigh Steere, Superior, CO (US); Jafar Nabkel, Longmont, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(73) Assignee: Tandem Readers, LLC, Denver, CO (US)

(21) Appl. No.: 12/044,627

(22) Filed: Mar. 7, 2008

(51) Int. Cl. G06F 17/30; G06F 15/16; G06F 3/048

(52) U.S. Cl. 715/727; 707/102; 709/219; 715/700; 707/E17.009

(57) ABSTRACT

A user is presented with a media selection that is delivered in discreet segments from a server computer over a distributed network to a client computer or other presentation device. The user can annotate each media segment and record, also in segments, a reading of any text of the media and any additional commentary, including observations or opinions regarding musical or video media streams. The voice data or recording, i.e., the “audio performance,” is either recorded over the network by the server computer, or transferred from the client computer or other presentation device over the network to the server computer. The segments of audio are synchronized with the media segments and assembled with prerecorded segment cues. In one implementation, a user, for example, a grandparent, can view the pages of a children's book through an Internet web browser, add or edit personal anecdotes, and read the book for page-by-page recording over a network to a storage server for later presentation to a grandchild.

### BACKGROUND

In modern society, extended families are often separated by great geographic distances due to circumstances of employment locations, retirement decisions, or merely personal preference for location and lifestyle. It may further be difficult for families to physically visit each other regularly due to the significant distance, cost of travel, or health conditions limiting or preventing travel. Modern technologies have helped bridge this divide by increasing the ease of communications between separated family members. The telephone network is the most obvious example. Additionally, computer networks such as the Internet have made it even easier for family members to quickly communicate with each other in many ways and formats. In addition to electronic mail messages and instant messaging, family members can exchange digital photographs and video as well as post such images to a family web site to allow access, viewing, and message posting by any family member. Further, third party service providers, e.g., photographic developers, have created Internet platforms for the presentation and viewing of electronic photo albums that allow families to share visual experiences and perhaps annotate the pictures with text comments. It is in the spirit of this background that the technology disclosed herein was developed as an alternative way for families to share and interact.

The information included in this Background section of the specification, including any references cited herein and any description or discussion thereof, is included for technical reference purposes only and is not to be regarded subject matter by which the scope of the invention is to be bound.

### SUMMARY

The disclosed technology enables a person, using a networked presentation device, for example, an Internet web browser on a computer, to view a presentation or stream of media presented in segments. The media, for example, images and/or text (e.g., pages of a book), music, or video, stored at or accessible by a network server may be delivered in discreet segments over a distributed network to a client computer or other presentation device. The person can annotate each media segment and record, in segments as well, e.g., a reading of the text of a book, and any additional commentary, including, for example, observations or opinions regarding musical or video media streams, from the network presentation device. The voice data or recording, i.e., the “audio performance,” may be transferred over the network to the server computer. The segments of audio may be synchronized with the media segments and assembled with prerecorded segment cues (e.g., “turn the page now”). In one implementation, the audio performance may be synchronized and assembled with a stream of the corresponding media.

In one exemplary implementation, the technology may be used to allow a person, for example, a grandparent, to view the pages of a children's book through an Internet web browser, to add or edit personal anecdotes, and to read the book for page-by-page recording over a network to a storage server for later presentation to a grandchild. Once recorded, the network server may write the audio recording to a physical media, for example, a compact disk (CD), digital versatile disk (DVD), or flash memory storage device. The CD may then be packaged with a printed copy of the book and sent to the grandchild. In an alternate embodiment, the grandchild may be provided a web link to download the audio recording, for example, as an MP3 file for presentation on an MP3 compatible device, and listen to the recording while viewing a printed copy of the book. In a further embodiment, the audio recording may be combined with a visual presentation of the pages of the book and stored on a CD or DVD that is packaged and shipped to the grandchild for presentation on a computer or DVD player. In yet another embodiment, the grandchild may simultaneously listen to the recorded audio while viewing an electronic copy of the book via a web browser.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTION OF THE DRAWINGS

FIG. 1 is a schematic diagram of an exemplary system for implementing the synchronized display of media and recording of audio over a network.

FIG. 2 is a schematic diagram of an exemplary browser interface for allowing a sender to view, annotate, and record an audio performance related to a media selection.

FIG. 3 is a flow diagram of exemplary operations for recording an audio performance and synchronizing the audio performance associated with a media selection across a network.

FIG. 4 is a flow diagram of operations for one exemplary implementation of fulfillment of a media and audio performance package for a recipient.

FIG. 5 is a flow diagram of operations for an alternative exemplary implementation of fulfillment of a media and audio performance package for a recipient.

FIG. 6 is a schematic diagram of an exemplary computer system for implementing operations for synchronizing the display of media and recording of audio over a network.

### DETAILED DESCRIPTION OF THE INVENTION

The synchronized display of multimedia and recording of audio may be realized across a communications network linking several pieces of computer hardware controlled by a combination of standard and special purpose software operating in conjunction to form a distributed system. The system may primarily include a client device, for example, a personal computer, connected via a network to a server computer that further manages one or more databases. The person who creates an audio recording over the network is referred to herein as the “sender.” Similarly, the person who receives the audio recording, often in conjunction with a book or other media, is referred to herein as the “recipient.” In a common implementation, a sender may use an Internet web browser operating on the client device to access a web site hosted by the server computer over a network.

In one exemplary implementation, the server computer may present a typical web store offering a variety of children's books. The sender is presented with an interface through which she is able to browse the available books, select one or more books, and then proceed to check out. Alternatively, purchase and checkout functions may be performed after the recording process is completed as further described below. The server computer may host a typical electronic commerce purchasing system that may be integrated or used in conjunction with the synchronized media presentation and recording software described herein.

Once a book is selected or purchased, the server computer may then present each page of the purchased book to the sender through the web browser interface. Controls may be provided in the web browser interface for control and navigation of the book. The web browser may present images of each page in the book, including text and illustrations, to allow the sender to record a performance of the book. For example, the “text and illustrations” may be a combination of text characters and a scalable illustration or fixed bitmap of an illustration, or a low-resolution bitmap of each page (including text as pixels in the bitmap), which is sufficient for display but not for high quality printing. Through the browser interface, the sender may have options to view each page of the book and to enter comments or notes in an annotation edit area associated with each page. These annotations may be a list of personal anecdotes, comments about the story, or a complete scripted dialogue the sender wants to record for a future playback by the recipient. The annotations are stored by the server computer on a network database associated with both the book and the sender for future use by the sender when recording a performance of the book.

Once a sender has reviewed the book, added any desired annotations, and is ready to record, the server computer will present the first page of the book in the browser interface. Instructions within the browser interface may prompt the sender to read the current page and include the sender's notes and anecdotes in the recording. The server computer marks each audio segment recorded by the sender corresponding to each page of the book and associates the audio segment with the corresponding book segment. Once the sender has completed recording a page, the browser interface may be updated to provide the sender with options to review the current recording for the page, to add an additional recorded segment (either through insertion or appendage), to cancel the recorded segment, record over with a new segment, to accept a recorded segment, and to save the current session to return later for further recording.

Once the sender has completed recording segments for each page of the book, the server computer synchronizes each recorded segment from the saved audio recordings of the sender's performance with the corresponding display segments, e.g., pages from the books. In one embodiment, the server computer may assemble the recorded performance and the media into an integrated multimedia format. Completed media and audio performance combinations may be made available in several different forms, for example, an audio CD recording of the performance, a flash media recording of the performance, a multimedia CD or DVD presentation of the performance, a multimedia streaming internet presentation, and other combinations. In embodiments in which the finished product is to be a tangible good, the completed audio performance may be transferred to a manufacturing or fulfillment center which delivers the finished goods, e.g., a CD and book package or a DVD, to the recipient.

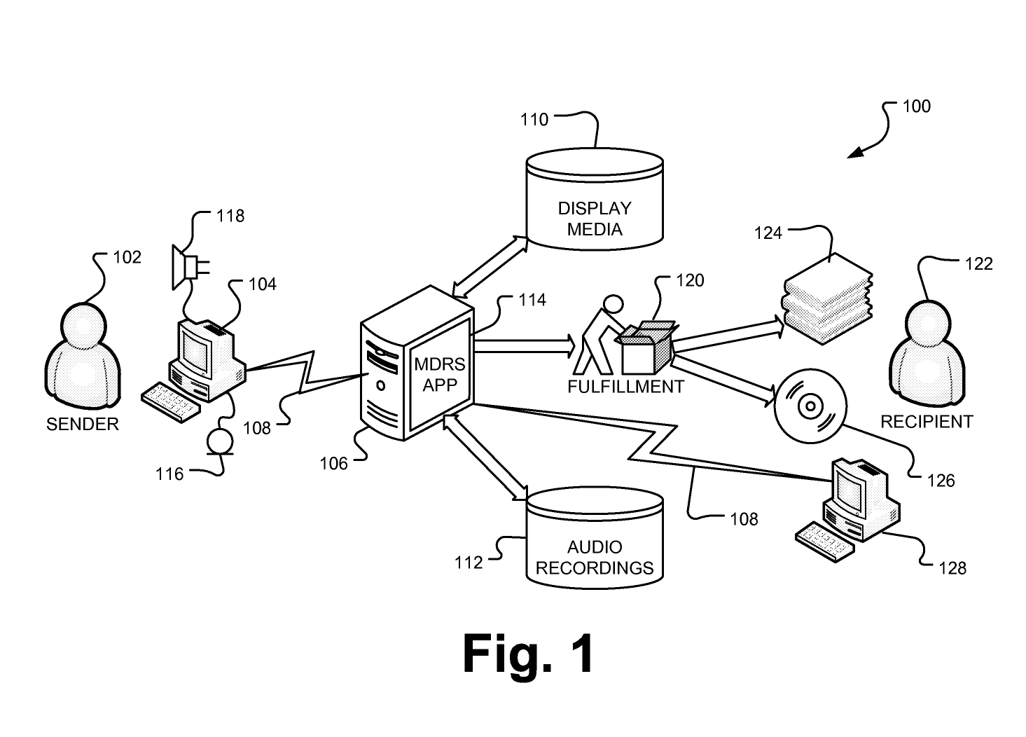

FIG. 1 depicts one exemplary implementation of a system 100 for synchronizing the display of multimedia and the recording of related audio across a network. The sender 102 may use a personal computer 104 or other computing or communication device to communicate with a network media server 106 over a wired or wireless network 108, or both. The media server 106 generally connects with the network 108 via a network link. The personal computer 104 may be a desktop computer, a laptop or notebook computer, a personal digital assistant, a smart phone, or any other computing or communication device that is capable of providing appropriate interface and connectivity functionality to communicate with the network media server 106 over the network 108. In many instances, the network 108 will likely be the Internet; however, other forms of public and private communications networks may likewise be used.

A media display, recording, and synchronization (MDRS) application 114 may execute on the network media server 106 to provide the primary functionality of the system 100. The network media server 106 may further maintain or have access to one or more media repositories. A presentation media data repository 110, e.g., a database, may store all available media files for use by the system 100. Such media files may include electronic copies of books, music, video, and other similar forms of media. Such media files may be categorized within the display media data repository 110 by one or more criteria, for example, by title, author, subject, target audience age, cost, and other similar criteria. The network server 106 may also be connected with an audio recording data repository 112 which stores audio recordings or “performances” made by multiple senders. The audio recording data repository 112 may index the audio recordings by sender name, sender identification number/code, media title, author, date of recording, and other similar criteria. The MDRS application 114 on the media server 106 provides an interface for indexing and control of reads and writes from and to the media data repository 110 and the audio recording data repository 112.

The MDRS application 114 may be designed to function as, or to interface with, the standard web service application to allow for simple access by a sender 102. Note, however, that this aspect of the system 100 may be implemented in a variety of different ways including, for example, in a direct client server application format. In an exemplary implementation, a sender may use an Internet browser application on her personal computer 104 to access a web site hosted on the network media server 106 over the network 108. The web site may be a component of the MDRS application 114 or it may operate as an intermediate interface to the MDRS application 114.

The web site on the media server 106 may present a typical web store interfaced to the sender 102 offering a variety of media files, for example, a selection of children's books. The sender will be able to search or browse the books or other media available through the web store, select one or more media titles for purchase, and then proceed to check out. At this point a typical electronic commerce processing platform may be used to complete the purchase of the media. This electronic commerce platform may be fully integrated in the MDRS application 114 or alternatively may be an adjunct software program utilized to complete a purchase transaction. Note that the actual “purchase” of the book might be done before or after recording the performance. In another implementation, for example, the sender may “select” a book, proceed and complete their recording, and then, before submitting their book for delivery, actually complete the ordering and payment process. This would allow a sender to be satisfied with the recorded results before paying, and then possibly to send the recorded book to multiple recipients.

Once the selection or purchase of the media item is completed, the MDRS application 114 may present a new interface to the sender 102 for creating audio recording of or associated with the media selection. As described in greater detail herein, the MDRS application 114 may provide one or more interfaces within the browser application on the sender's computer 104 to present the sender options to view the selected media in segments (e.g., each page of the book). The browser interface implemented by the MDRS application 114 may further allow a user to enter comments or annotations to be associated with particular segments of the media file. The MDRS application 114 may store the sender's annotations in a network database that is associated with both the sender, e.g., through a unique identification number, and with the media selection itself.

After the sender 102 has reviewed the media selection and has added any desired annotations, the MDRS application 114 may enter into a recording mode. The sender 102 may progress through the media segment-by-segment (e.g., page-by-page in a book) and read the text and provide commentary for each segment that is recorded by the MDRS application 114. The system 100 may support multiple modes of recording, for example, by installing a specific client software module on the sender's computer 104, by using various voice over internet protocols (VOIP), or by using other web browser based recording software (e.g., ActiveX, Java, Ajax, Flex, or other browser-based technologies). In this implementation, the sender's computer 104 may be equipped with a microphone 116 and one or more loudspeakers 118, either of which may be built-in or external to the sender's computer 104.

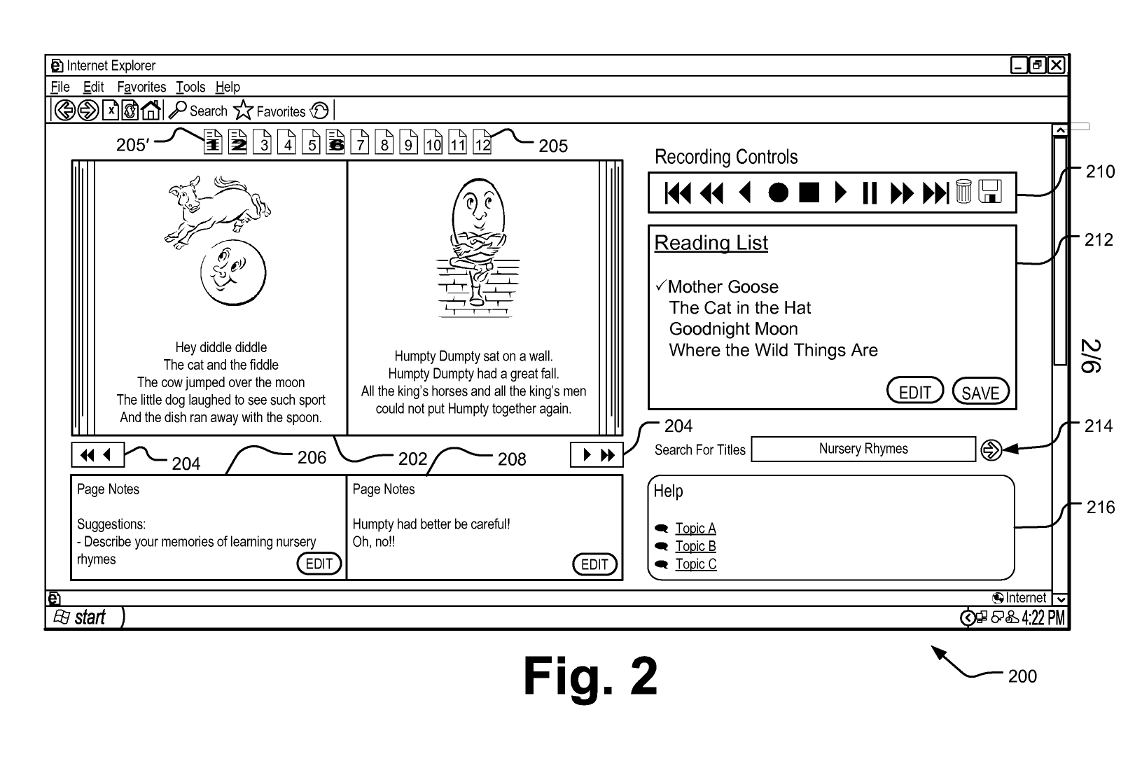

The MDRS application 114 may next provide tools within the browser interface for allowing the sender 102 to effectuate a recording of the media selection. The MDRS application 114 may begin a recording session by presenting the first media segment of the media selection (e.g., the first page of the book) along with instructions to the sender 102 to read the current media segment as well as provide any additional comments or anecdotes as desired. In addition to displaying the media segment, the MDRS application 114 may further present any annotations previously entered by the sender 102 in order to aid the sender 102 during the recording process as further described in greater detail below with respect to FIG. 2. In one implementation, audio data may simply be collected at the sender's computer 104 and directly transmitted to the server computer 106, for example, using voice over internet protocols (VOIP). In another implementation, the audio data input by the sender may be streamed (e.g., using Flash or Real Audio software) from the sender's computer 104 to the server computer 106. In yet another implementation, audio data may be collected, for example, by installing a specific client software audio recording module on the sender's computer 104 or by using other web browser based recording software (e.g., ActiveX, Java, Ajax, Flex, or other browser-based technologies).

Once a recording for a particular media segment is completed, the MDRS application 114 may mark each audio segment recorded by the sender 102 by associating the audio segment with a unique identifier of the sender 102 and further associating the recorded segment with the corresponding media segment. Recording of the media selection will continue in this fashion on a segment-by-segment basis until the entire media selection has been recorded. The sender 102 may be provided with options to review the current recording for each segment before progressing to the next segment by listening to the recording via the loud speaker 118 at the sender's computer 104, to cancel the recorded segment and record a new segment, to edit a recorded segment by inserting additional comments or appending additional comments to the end of the segment, and to accept a recorded segment in order to proceed to the next segment. In addition, the MDRS application 114 may allow the sender 102 to suspend and store the current recording session to return at a later time to complete the recording of the media selection.

Once a sender has completed a recording of all segments for a particular media selection, the segments of the audio performance are synchronized or mapped to the corresponding segments of the media selection. Because the sender may record in segments and may further rerecord some of those segments, there is a likelihood that the finished recorded performance will have different audio volumes between the sections. This variance in recoding levels between recorded segments may be caused, for example, by differing positions of the microphone, differing distances of the sender to the microphone, sender adjustment of input gain, or other disparities in the recording input. To address any inconsistencies in recording levels between segments, the MDRS application 114 may incorporate editing software to ensure even sound quality and volume throughout. Such audio editing functions may be automated so that all recording segments are edited against pre-established criteria for normalization before compiling a complete recorded performance.

The MDRS application 114 may further automatically annotate each recorded segment for ease of use by the recipient. For example, the MDRS application 114 may insert pauses between recorded segments to allow a recipient 122 to move to the next media segment, e.g., turn the page of a book. Additionally, audio cues, for example, audible directions to turn to the next page, may also be inserted between the recorded audio segments. The completed recording of a media selection may then be stored in the audio recording data repository 112 for later and potentially perpetual access in a one time or on-demand fulfillment process. Alternately, the sender may be given the option to record one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

In one exemplary implementation, a fulfillment process 120 may be at least partially manually implemented. Once a sender's recording has been completed, the MDRS application 114 may generate fulfillment instructions identifying a recipient 122 and a corresponding shipping address provided by the sender 102 and associate this recipient information with an identification of the sender's media selection and/or a related audio recording made by the sender 102. The audio recording may be automatically copied to a physical media, for example, a CD, flash storage device, or DVD, by the MDRS application 114, or such a copy of the sender's recording may be initiated manually as part of the fulfillment process 120. In this implementation, a copy of the media selection, e.g., a book, and a copy of the corresponding audio recording 126, e.g., a CD or DVD, may be packaged together for shipment to the recipient 122. Upon receipt of the shipment, the recipient 122 may play the audio media 126 while simultaneously following along with a copy of the physical media 124 (e.g., a book).

In an alternate fulfillment embodiment, the recipient 122 may be notified of the availability of a media selection and corresponding audio recording prepared by the sender 102 for the recipient's benefit. Such a notification may come in the form of an electronic mail message sent by the MDRS application 114 from the network server 106 to a computing device 128 associated with the recipient 122. Alternately, the MDRS application 114 may send an electronic message to another mail distribution server which, in turn, sends it to the computing device 128 associated with the recipient 122. The recipient's computing device 128 may be connected with the network server 106 via the network 108, for example, the Internet (whether wired or wireless), or via a similar network. In one embodiment of this implementation, the media selection and accompanying audio recording of the sender 102 may be sequentially served or streamed to the recipient's computing device 128 for presentation in a browser interface. Alternatively, the recipient may download a complete copy of the media selection and the associated audio recording from the sender 102 for local presentation on the recipient's computing device 128. In a hybrid implementation, the media selection 124 may be manually fulfilled, e.g., by shipping a copy of the book to the recipient 122, while the audio recording of the sender 102 may be fulfilled electronically, e.g., by the recipient 122 downloading a copy of the audio file from the network server 106 to the recipient's computing device 128. The audio file may be in any known form, for example, MP3, WMV, MPEG, or other digital format, and may be played back on the recipient's computing device 128 or transferred to another playback device, e.g., an MP3 player.

An exemplary browser interface 200 for facilitating the synchronization of the media display and audio recording is presented in FIG. 2. The sender's media selection 202, in this example in the form of a children's book, is presented in the browser window 200. It may be desirable to present the media selection 202 within the browser window 200 in the same or almost identical format as the media selection that will ultimately be received by the recipient. For example, if the recipient will receive a printed copy of a book, the media selection 202 displayed in the browser window 200 may depict text and images in the same manner and fashion as the text and images are printed in the book in order to allow the sender to record and comment on exactly what the recipient will see. This may be achieved by presenting a bitmap image or other digital image format of the pages of the book. For example, the text and images may be a combination of text characters and a scalable illustration or fixed bitmap of an illustration, or a low-resolution bitmap of each page (including text as pixels in the bitmap), which is sufficient for display but not for high quality printing.

The browser interface 200 may also provide the sender with media segment selection controls 204 as an interface feature. In the example of a book, the segment selection controls 204 may allow the sender to move forward or backward through the book page by page or alternately to skip to the beginning or the end of the book. In addition, or in an alternate embodiment, the browser interface 200 may also includes small page icons 205 which allow the sender to navigate easily through the pages of the book and visually see which pages have already been recorded, e.g. as a highlighted page icon 205′. In addition, the browser interface 200 may provide annotation windows 206, 208 associated with each media segment of the media selection 202 as another interface feature. The sender may use the annotation windows 206, 208 to enter notes, comments, and reminder cues of additional anecdotes the user would like to make while recording the text of the media selection (e.g., reading a story). Editing within the annotation windows 206, 208 may be controlled through the selection of an edit button to prevent accidental overwriting or deletion of previously inserted comments.

In the example depicted in FIG. 2, the first annotation window 206 provides a suggested annotation to the sender in the event the sender has difficulty developing her own comments or anecdotes. In this example, the media selection 202 is a book of nursery rhymes and the suggested commentary directs the sender to “describe your memories of learning nursery rhymes.” As shown in the second annotation window 208, the sender has already inserted comments that she would like to make in conjunction with the Humpty Dumpty nursery rhyme exclaiming that “Humpty had better be careful!” and “Oh, no!!” when the character falls off the wall.

The browser interface 200 may further provide the sender with a selection of recording controls 210 for use in recording the text of the media segment 202 and any accompanying comments and anecdotes. The recording controls 210 may include several functions, for example, skip to beginning, fast rewind, rewind, record, stop, play, pause, fast-forward, skip to end, erase, and save. While the browser interface shows a selection of manual recording controls 210, this is merely one exemplary implementation of a possible recording feature. In other implementations, the browser interface 200 could direct the recording process through the use of a “wizard” module that would lead the sender through a series of steps to assist the sender in recording, reviewing, and saving a sound recording of a performance of each media segment 202.

The browser interface 200 may provide additional functionality for a sender. For example, the browser interface 200 may provide a reading list window 212 through which the sender can view a list of media selections purchased for recording and sending to recipients. The reading list window 212 may provide an indication of which media selection is presently selected for recording an annotation; in this instance, Mother Goose is shown as selected. In some implementations, the media selection presented in the reading list window 212 may be perpetual thereby allowing a sender to send a media selection and associated sound recording to multiple recipients at various times, or to edit the sound recordings to prepare a number of customized recorded performances of a particular media selection for each of multiple recipients. In a further implementation, the MDRS application may allow a sender to create and store different versions of recordings for a particular media selection for fulfillment to different recipients.

The browser interface 200 may further provide a search bar 214 to provide for keyword searching of media selections, for example, by subject matter, title, author, etc. In some embodiments, the search results could be presented in a window within the browser interface 200, for example, temporarily replacing the reading list window 212. In other embodiments, search results could be presented in an entirely new browser window. Selection of a new media title as a result of a search may transfer the sender into a purchasing module in order to purchase a chosen media selection for recording and ultimate fulfillment. Once the purchase transaction is complete, the user may be returned to the browser interface 200 and the newly purchased media selection may appear in the reading list window 212.

The browser interface 200 may further be provided with a help window 216. The help window may be intuitive and provide on-screen, step-by-step instructions to the sender depending upon what step in the annotation and recording process the sender is at. Alternately, or in addition, the help window 216 may be searchable by topic index or keyword to allow a sender to locate help for a specific question or problem the sender is experiencing. Further, the help window 216 may provide access to a “digital assistant” through a series of pre-recorded tutorial and trouble-shooting videos which are displayed using streaming media, or other similar technologies, within the help window 216 of browser window 200, or in an entirely new browser window.

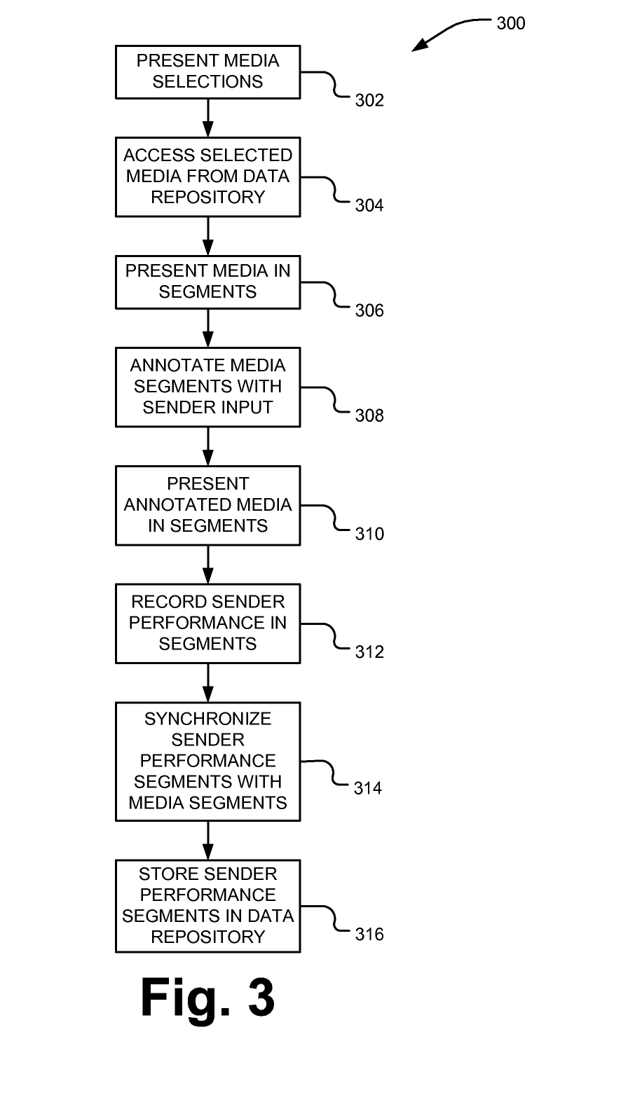

An exemplary process 300 for synchronizing a display of media and recording audio of the sender across the network is depicted in FIG. 3. Initially, in a presentation operation 302, media selections, for example, a selection of books, are presented to the sender in a browser interface. It should be understood that other forms of media in addition to books, for example, music (e.g., songs for karaoke singing), video (e.g., for commentary or narration), and other similar forms of media, may be presented to the sender for selection and recording.

Upon receipt of a media selection from a sender, the selected media file may be accessed from a data store in accessing operation 304. The media file may be processed by the MDRS application for presentation of the media selection in segments, such as, for example, pages of a book, or “chapters” of a video, as indicated in presentation operation 306. As described above, the media selection segments may be presented to a sender, for example, through the use of a browser interface. The browser interface may provide additional controls to the sender for recording of the text with annotation and commentary. Upon receipt of annotation comments from the sender, the annotation information is associated with the corresponding media segment in the media file in annotation operation 308.

The recording phase of the process 300 begins by presenting the annotated media segments to the user in presentation operation 310. The annotated media segments may be presented serially. However, the process 300 may provide functionality to the sender to allow for self directed recording. The sender's performance of the media selection is then recorded on a segment by segment basis as indicated in recording operation 312. The recorded segments may then be synchronized with the respective media segments in synchronizing operation 314. Each of the recorded segments may be tagged or marked with identification information to track the association of the recorded segments with a particular sender, with each other, and with the media selection and the media segments. These associations may take place through the use of database tables, file headers for each recorded segment, or other well known data indexing or identification methodologies. Each of the sender's recorded performance segments may then be stored in a database repository in storing operation 316.

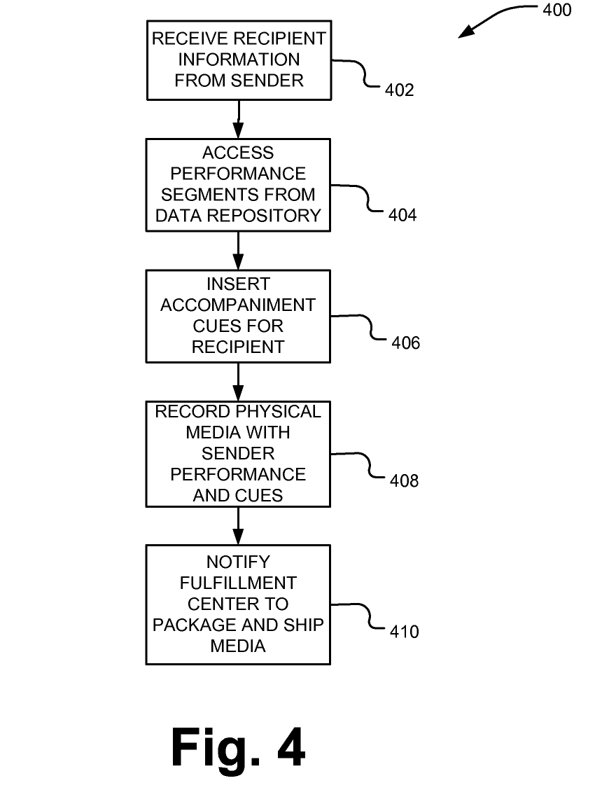

One exemplary implementation of a fulfillment process 400 for providing the recipient with copies of the sender's media selection and recorded performance are presented in FIG. 4. In order to initiate the fulfillment process 400, identification information for the recipient must be known. Such identification information may include the recipient's name, a mailing address, an e-mail address, a telephone number, or other contact information. This contact information may be received from the sender in receiving operation 402.

Once a particular recipient is identified and a media selection and recorded performance are associated with the recipient, the recorded performance segments may be accessed from the data repository in accessing operation 404. If not previously completed during the process of recording the sender's performance, accompaniment cues may be inserted between the performance segments for the benefit of the recipient as indicated in inserting operation 406. Exemplary accompaniment cues may include extended pause periods between recorded segments, for example, to allow a recipient to view pictures accompanying text on the page of a book. Other accompaniment cues may instruct the recipient to turn the page when viewing a book. Alternately, the sender may be given the option of recording one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

Once any accompaniment cues have been inserted into the performance segments, the entire performance of the sender may be recorded to a physical media for example by burning a CD or DVD with the performance data as indicated in recording operation 408, or copying the performance data to a flash memory storage media. Once a sender's performance has been recorded onto physical media, a fulfillment center may be notified to package the recorded media in conjunction with the media selection of the sender, e.g., the accompanying book, and ship the package to the recipient using the contact information collected from the sender as indicated in notifying operation 410.

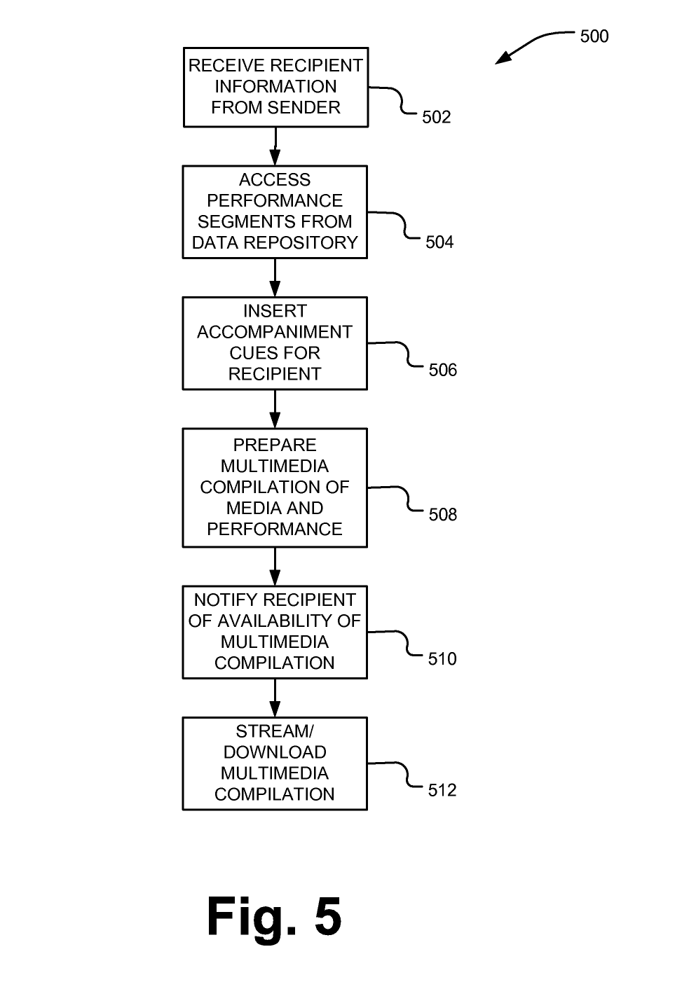

An alternate implementation of a fulfillment process 500 is depicted in FIG. 5. In order to initiate the fulfillment process 500, identification information for the recipient must be known. Such identification information may include the recipient's name, a mailing address, an e-mail address, a telephone number, or other contact information. This contact information is received from the sender in receiving operation 502.

Once a particular recipient is identified and a media selection and recorded performance are associated with the recipient, the recorded performance segments may be accessed from the data repository in accessing operation 504. If not previously completed during the process of recording the sender's performance, accompaniment cues may be inserted between the performance segments for the benefit of the recipient as indicated in inserting operation 506. Exemplary accompaniment cues may include extended pause periods between recorded segments, for example, to allow a recipient to view pictures accompanying text on the page of a book. Other accompaniment cues may instruct the recipient to turn the page when viewing a book. Alternately, the sender may be given the option of recording one or more custom audio cues in the sender's voice which instruct the recipient to proceed to the next page. These custom audio cues, may include, for example, “Turn the page now,” or “Let's see what's next by turning the page,” or “Are you ready? Let's go to the next page!”

Once any accompaniment cues have been inserted into the performance segments, a multimedia compilation of the media selection and the sender's recorded performance may be prepared in preparation of operation 508. For example, in the case of a book, bitmap images of each page of the book, including text and illustrations, may be time synchronized for display with the sender's recorded performance for that particular page of the book. Alternatively, if the selected media is a song, the sender's performance of the song may be synchronized and overlaid with the instrumental tracks of the song to create a karaoke performance. Further if the selected media is a video, the sender's commentary or narration may be synchronized with the video to create a complete multimedia compilation.

Once a multimedia compilation is complete, the recipient may be notified of the availability of the multimedia compilation as indicated in notification operation 510. This notification may be in the form of an electronic mail message sent, and/or a wireless phone “text message,” and/or an “instant” chat message, and/or a voice mail message, to an address of the recipient that is provided by the sender. Upon receipt of the notification message, a recipient may access the multimedia compilation, e.g., by selecting a hyperlink provided in the notification message or by using a browser program to navigate to a website that can provide the recipient access to the multimedia compilation.

Once the recipient locates the multimedia compilation, it may be presented to the user in any of several forms. For example, the user may download a file containing the multimedia compilation for playback on the recipient's computing device using standard media presentation software. Alternatively, the multimedia compilation may be presented to the user through the user's browser interface in the form of a streaming multimedia presentation. In a further implementation, fulfillment of the media selection may be performed by sending the recipient a physical copy of the media selection, e.g., a book, while the accompanying audio performance of the sender may be provided through a download of an audio file, e.g., an MP3 file, to the recipient's computing device. Playback of the audio file may be performed by recipient's computing device using standard audio player applications. Alternatively, the audio file may be copied from the recipient's computing device to an alternative playback device, for example, an MP3 player, or burned to a physical medium, e.g., a CD, for playback by the recipient using other devices then the recipient's computing device connected to the network.

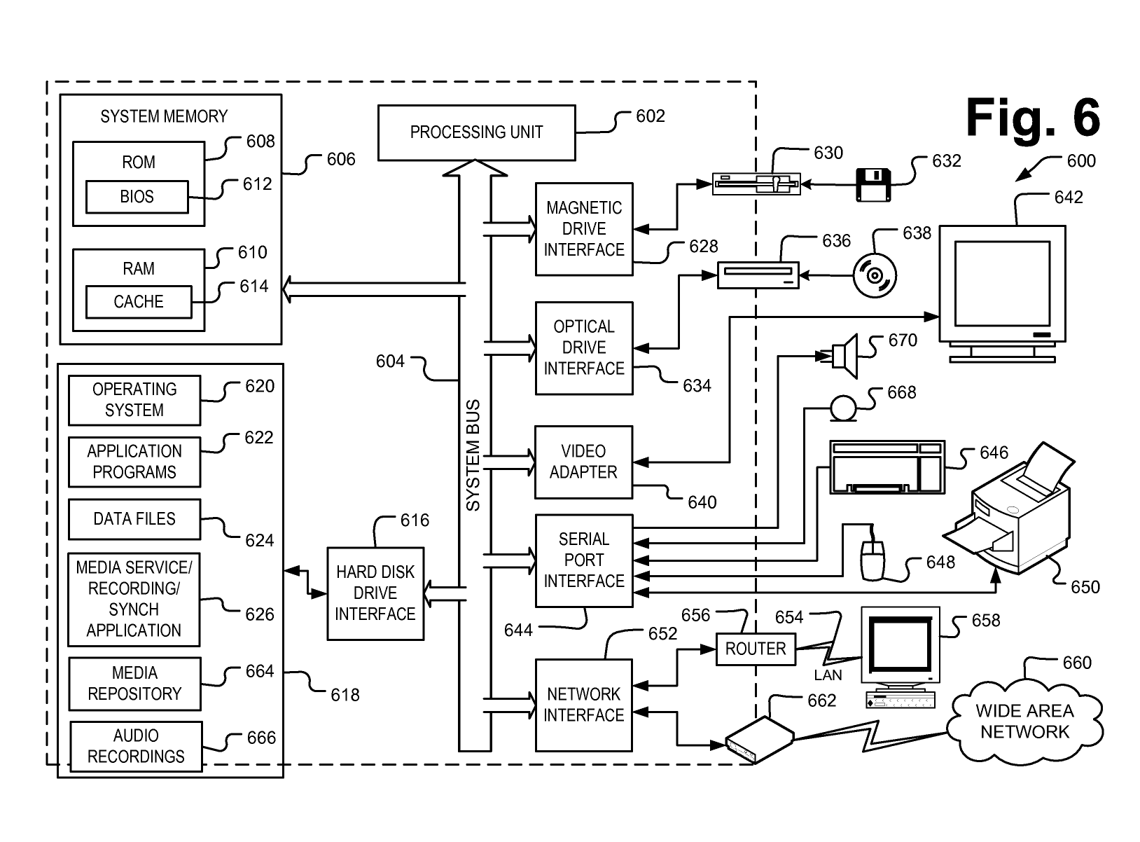

An exemplary computer system 600 for implementing the file origin determination processes above is depicted in FIG. 6. The computer system 600 of a sender or a recipient may be a personal computer (PC), a workstation, a notebook or portable computer, a tablet PC, a handheld media player (e.g., an MP3 player), a smart phone device, a video gaming device, or a set top box, with internal processing and memory components as well as interface components for connection with external input, output, storage, network, and other types of peripheral devices. Internal components of the computer system in FIG. 6 are shown within the dashed line and external components are shown outside of the dashed line. Components that may be internal or external are shown straddling the dashed line. Alternatively to a PC, the computer system 600, for example, for running the MDRS application, may be in the form of any of a server, a mainframe computer, a distributed computer, an Internet appliance, or other computer devices, or combinations thereof.

In any embodiment or component of the system described herein, the computer system 600 includes a processor 602 and a system memory 606 connected by a system bus 604 that also operatively couples various system components. There may be one or more processors 602, e.g., a single central processing unit (CPU), or a plurality of processing units, commonly referred to as a parallel processing environment (for example, a dual-core, quad-core, or other multi-core processing device). The system bus 604 may be any of several types of bus structures including a memory bus or memory controller, a peripheral bus, a switched-fabric, point-to-point connection, and a local bus using any of a variety of bus architectures. The system memory 606 includes read only memory (ROM) 608 and random access memory (RAM) 610. A basic input/output system (BIOS) 612, containing the basic routines that help to transfer information between elements within the computer system 600, such as during start-up, is stored in ROM 608. A cache 614 may be set aside in RAM 610 to provide a high speed memory store for frequently accessed data.

A hard disk drive interface 616 may be connected with the system bus 604 to provide read and write access to a data storage device, e.g., a hard disk drive 618, for nonvolatile storage of applications, files, and data. A number of program modules and other data may be stored on the hard disk 618, including an operating system 620, one or more application programs 622, and data files 624. In an exemplary implementation, the hard disk drive 618 may store the media service, recording, and synchronization application 626, the media data repository 664 for storage of media selections for presentation to a sender, and the audio recording data repository 666 for storing audio performances recorded by a sender according to the exemplary processes described herein above. Note that the hard disk drive 618 may be either an internal component or an external component of the computer system 600 as indicated by the hard disk drive 618 straddling the dashed line in FIG. 6. In some configurations, there may be both an internal and an external hard disk drive 618.

The computer system 600 may further include a magnetic disk drive 630 for reading from or writing to a removable magnetic disk 632, tape, or other magnetic media. The magnetic disk drive 630 may be connected with the system bus 604 via a magnetic drive interface 628 to provide read and write access to the magnetic disk drive 630 initiated by other components or applications within the computer system 600. The magnetic disk drive 630 and the associated computer-readable media may be used to provide nonvolatile storage of computer-readable instructions, data structures, program modules, and other data for the computer system 600.

The computer system 600 may additionally include an optical disk drive 636 for reading from or writing to a removable optical disk 638 such as a CD ROM or other optical media. The optical disk drive 636 may be connected with the system bus 604 via an optical drive interface 634 to provide read and write access to the optical disk drive 636 initiated by other components or applications within the computer system 600. The optical disk drive 630 and the associated computer-readable optical media may be used to provide nonvolatile storage of computer-readable instructions, data structures, program modules, and other data for the computer system 600.

A display device 642, e.g., a monitor, a television, or a projector, or other type of presentation device may also be connected to the system bus 604 via an interface, such as a video adapter 640 or video card. Similarly, audio devices, for example, external speakers or a microphone (not shown), may be connected to the system bus 604 through an audio card or other audio interface (not shown).

In addition to the monitor 642, the computer system 600 may include other peripheral input and output devices, which are often connected to the processor 602 and memory 606 through the serial port interface 644 that is coupled to the system bus 606. Input and output devices may also or alternately be connected with the system bus 604 by other interfaces, for example, a universal serial bus (USB), an IEEE 1394 interface (“Firewire”), a parallel port, or a game port. A user may enter commands and information into the computer system 600 through various input devices including, for example, a keyboard 646 and pointing device 648, for example, a mouse. Other input devices (not shown) may include, for example, a joystick, a game pad, a tablet, a touch screen device, a satellite dish, a scanner, a facsimile machine, and a digital camera, and a digital video camera. In implementations described herein, the computer system 600 of the sender may include a microphone 668 to capture the sender's performance. Output devices may include a printer 650 and one or more loudspeakers 670 for presenting the audio performance of the sender. Other output devices (not shown) may include, for example, a plotter, a photocopier, a photo printer, a facsimile machine, and a press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 600 via the serial port interface 644 (e.g., USB) or similar port interface.

The computer system 600 may operate in a networked environment using logical connections through a network interface 652 coupled with the system bus 604 to communicate with one or more remote devices. The logical connections depicted in FIG. 6 include a local-area network (LAN) 654 and a wide-area network (WAN) 660. Such networking environments are commonplace in home networks, office networks, enterprise-wide computer networks, and intranets. These logical connections may be achieved by a communication device coupled to or integral with the computer system 600. As depicted in FIG. 6, the LAN 654 may use a router 656 or hub, either wired or wireless, internal or external, to connect with remote devices, e.g., a remote computer 658, similarly connected on the LAN 654. The remote computer 658 may be another personal computer, a server, a client, a peer device, or other common network node, and typically includes many or all of the elements described above relative to the computer system 600.

To connect with a WAN 660, the computer system 600 typically includes a modem 662 for establishing communications over the WAN 660. Typically the WAN 660 may be the Internet. However, in some instances the WAN 660 may be a large private network spread among multiple locations, or a virtual private network (VPN). The modem 662 may be a telephone modem, a high speed modem (e.g., a digital subscriber line (DSL) modem), a cable modem, or similar type of communications device. The modem 662, which may be internal or external, is connected to the system bus 618 via the network interface 652. In alternate embodiments the modem 662 may be connected via the serial port interface 644. It should be appreciated that the network connections shown are exemplary and other means of and communications devices for establishing a network communications link between the computer system and other devices or networks may be used.

The technology described herein may be implemented as logical operations and/or modules in one or more systems. The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

In some implementations, articles of manufacture are provided as computer program products. In one implementation, a computer program product is provided as a computer-readable medium storing an encoded computer program executable by a computer system. Another implementation of a computer program product may be provided in a computer data signal embodied in a carrier wave by a computing system and encoding the computer program. Other implementations are also described and recited herein.

The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A system for synchronizing a presentation of media and recording of audio across a network comprising
a first data repository for storing a collection of media files;
a second data repository for storing a collection of recorded audio performances corresponding to one or more of the media files;
a network link; and
a server computer configured to
access a media file from the first data repository and present the accessed media file to a sender device via the network link;
receive audio data from the sender device via the network link corresponding to the accessed media file;
synchronize the audio data with the accessed media file; and
save the synchronized audio data as one of the recorded audio performances in the second data repository.

2. The system of claim 1, wherein the server computer is further configured to record the audio data which is input at the sender device and received via the network link.

3. The system of claim 2, wherein the server computer is further configured to process the received audio data formatted using a set of voice over internet protocols.

4. The system of claim 1, wherein the server computer is further configured to present the accessed media file in media segments to the sender device.

5. The system of claim 4, wherein the server computer is further configured to record the audio data which is input at the sender device and received via the network link in audio segments corresponding to respective media segments.

6. The system of claim 4, wherein the server computer is further configured to
provide a first interface feature to the sender device for presenting one of the media segments at a time on the sender device; and
provide a second interface feature to the sender device allowing a sender to input annotation information corresponding to a respective one of the media segments as cues during recording of a corresponding one of the audio segments.

7. The system of claim 4, wherein the server computer is further configured to provide an interface to the sender device for presenting one of the media segments at a time on the sender device and including segment control features allowing a sender to select among the media segments for presentation.

8. The system of claim 1, wherein the server computer is further configured to provide an audio recording module to the sender device for recording audio input by a sender at the sender device to create the audio data.

9. The system of claim 1, wherein the server computer is further configured to provide an interface to the sender device including recording controls allowing a sender to control input and editing of the audio data.

10. A method for synchronizing a presentation of media and recording of audio across a network comprising
storing a collection of media files in a first data repository;
accessing a media file from the first data repository;
presenting the accessed media file to a sender device via a network link;
receiving audio data corresponding to the media file from the sender device via the network link;
synchronizing the audio data with the accessed media file; and
storing the synchronized audio data as one of a collection of recorded audio performances in a second data repository corresponding to one or more of the media files in the first data repository.

11. The method of claim 10 further comprising recording the audio data which is input at the sender device and received via the network link.

12. The method of claim 10 further comprising processing the received audio data formatted using a set of voice over internet protocols.

13. The method of claim 10 further comprising
separating the accessed media file into a group of media segments; and
presenting the media segments to the sender device.

14. The method of claim 13 further comprising recording the audio data which is input at the sender device and received via the network link in audio segments corresponding to respective media segments.

15. The method of claim 13 further comprising
providing a first interface feature to the sender device for presenting one of the media segments at a time on the sender device; and
providing a second interface feature to the sender device allowing a sender to input annotation information corresponding to a respective one of the media segments as cues during recording of a corresponding one of the audio segments.

16. The method of claim 13 further comprising providing an interface to the sender device for presenting one of the media segments at a time on the sender device, the interface further including segment control features allowing a sender to select among the media segments for presentation.

17. The method of claim 10 further comprising providing an audio recording module to the sender device for recording audio input by a sender at the sender device to create the audio data.

18. The method of claim 10 further comprising providing an interface to the sender device including recording controls allowing a sender to control input and editing of the audio data.

19. A computer-readable medium storing computer-readable instructions for controlling a server computer to synchronize a presentation of media and recording of audio across a network, wherein the instructions comprise operations to
store a collection of media files in a first data repository;
access a media file from the first data repository;
present the accessed media file to a sender device via a network link;
receive audio data corresponding to the media file from the sender device via the network link;
synchronize the audio data with the accessed media file; and
store the synchronized audio data as one of a collection of recorded audio performances in a second data repository corresponding to one or more of the media files in the first data repository.

20. The computer readable medium of claim 19, wherein the instructions further comprise operations to record the audio data which is input at the sender device and received via the network link.

21. The computer readable medium of claim 19, wherein the instructions further comprise operations to process received audio data formatted using a set of voice over internet protocols.

22. The computer readable medium of claim 19, wherein the instructions further comprise operations to
separate the accessed media file into a group of media segments; and
present the media segments to the sender device.

23. The computer readable medium of claim 22, wherein the instructions further comprise operations to record the audio data which is input at the sender device and received via the network link in audio segments corresponding to respective media segments.

24. The computer readable medium of claim 22, wherein the instructions further comprise operations to
provide a first interface feature to the sender device for presenting one of the media segments at a time on the sender device; and
provide a second interface feature to the sender device allowing a sender to input annotation information corresponding to a respective one of the media segments as cues during recording of a corresponding one of the audio segments.

25. The computer readable medium of claim 22, wherein the instructions further comprise operations to provide an interface to the sender device for presenting one of the media segments at a time on the sender device, wherein the interface includes segment control features allowing a sender to select among the media segments for presentation.

26. The computer readable medium of claim 19, wherein the instructions further comprise operations to provide an audio recording module to the sender device for recording audio input by a sender a the sender device to create the audio data.

27. The computer readable medium of claim 19, wherein the instructions further comprise operations to provide an interface to the sender device including recording controls allowing a sender to control input and editing of the audio data.
